(19) United States
(12) Patent Application Publication
(10) Pub. No.: US 2016/0172924 A1
(43) Pub. Date: Jun. 16, 2016

(54) MOTOR WITH ADHESIVE STRUCTURE BETWEEN BASE AND SHAFT SUPPORTING MEMBER

(71) Applicant: MINEBEA CO., LTD., Kitasaku-gun (JP)

(72) Inventors: Hideaki SHOWA, Kitasaku (JP); Daigo NAKAJIMA, Tomi (JP); Naoyuki KONDO, Kitasaku (JP)

(21) Appl. No.: 14/962,474

(22) Filed: Dec. 8, 2015

(30) Foreign Application Priority Data
Dec. 10, 2014 (JP) 2014-249979

(51) Int. Cl. H02K 5/167

(52) U.S. Cl. CPC H02K 5/167; H02K 5/1677

(57) ABSTRACT

A motor includes: a base including a holder portion; a shaft supporting member fitted inside the holder portion and fixed onto an inner circumferential surface of the holder portion; a shaft supported by the shaft supporting member; a rotor assembly rotatably supported with respect to the shaft supporting member via the shaft; and a stator assembly arranged on an outer circumferential portion of the holder portion. An adhesive groove on the base side and an adhesive groove on the shaft supporting member side, to which an adhesive is applied, are formed respectively on the inner circumferential surface of the holder portion and on an outer circumferential surface of the shaft supporting member facing the inner circumferential surface of the holder portion, and the adhesive grooves on the base side and on the shaft supporting member side are disposed to face each other at least in part.

### CROSS-REFERENCE TO RELATED APPLICATION

The present application claims priority to and incorporates by reference the entire contents of Japanese Patent Application No. 2014-249979 filed in Japan on Dec. 10, 2014.

### BACKGROUND OF THE INVENTION

1. Field of the Invention

The present invention relates to a motor such as a spindle motor, and in particular, to an adhesive bonding structure between a base and a sleeve supporting a shaft.

2. Description of the Related Art

A spindle motor has been used as a driving source of a hard disk drive used in computers, for example, and in recent years, higher rotational speed and accuracy of spindle motor have been desired because a farther increase in data capacity and higher data reading and writing speed have been in demand. In general, such a spindle motor is configured to rotatably support a shaft by a sleeve fixed in a base that is a fixing member via a bearing such as a hydrodynamic bearing. A stator assembly is also attached on the base and a rotor assembly is fixed to the shaft. When a coil of the stator assembly is energized the rotor assembly and the shaft rotates.

The sleeve that rotatably supports the shaft is fitted in a cylindrical portion formed on the base, and is fixed onto the inner circumferential surface of the cylindrical portion by adhesive. In such a fixation structure, known is a configuration in which a sleeve is bonded to a base by applying an adhesive into an adhesive groove provided on the outer circumferential surface of the sleeve (Japanese Patent Application Laid-open No. 2006-017299).

This sort of spindle motors is required to ensure sufficient impact resistance. However, it has been found that, when an adhesive groove is formed only on the base or the sleeve, the adhesive strength may deteriorate after receiving a major impact.

Therefore a spindle motor with an improved adhesive strength between the base and a shaft supporting member such as the sleeve after receiving an impact is required.

### SUMMARY OF THE INVENTION

It is an object of the present invention to at least partially solve the problems in the conventional technology.

According to one aspect of the present invention, there is provided a motor including: a base including a holder portion; a shaft supporting member fitted inside the holder portion and fixed onto an inner circumferential surface of the holder portion; a shaft supported by the shaft supporting member; a rotor assembly rotatably supported with respect to the shaft supporting member via the shaft; and a stator assembly arranged on an outer circumferential portion of the holder portion, wherein an adhesive groove on the base side and an adhesive groove on the shaft supporting member side, to which an adhesive is applied, are formed respectively on the inner circumferential surface of the holder portion and on an outer circumferential surface of the shaft supporting member facing the inner circumferential surface of the holder portion, and the adhesive groove on the base side and the adhesive groove on the shaft supporting member side are disposed to face each other at least in part.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a sectional side view of a spindle motor (a rotary shaft type) according to a first embodiment;

FIGS. 2A and 2B are enlarged views of a portion II in FIG. 1, FIG. 2A illustrating an adhesive bonding structure between a base and a sleeve according to the first embodiment, and FIG. 2B illustrating an adhesive bonding structure between a base and a sleeve according to a second embodiment;

FIG. 3 is an enlarged sectional view illustrating adhesive grooves according to the second embodiment;

FIG. 4 is a sectional side view of a spindle motor (a fixed-shaft type) according to a third embodiment;

FIGS. 5A and 5A are enlarged views of a portion V in FIGS. 4, and 5A illustrating the adhesive bonding structure between the base and the sleeve according to the first embodiment, and FIG. 5B illustrating the adhesive bonding structure between the base and the sleeve according to the third embodiment;

FIG. 6 is a sectional view illustrating an adhesive bonding structure between a base and a sleeve according to a test body of a comparative example on which an adhesive strength test has been conducted in examples; and

FIG. 7 is a chart illustrating the results of the adhesive strength test conducted in the examples.

### DETAILED DESCRIPTION OF THE PREFERRED EMBODIMENTS

With reference to the accompanying drawings, the following describes exemplary embodiments in which the present invention is applied to spindle motors.

Basic Structure of Spindle Motor

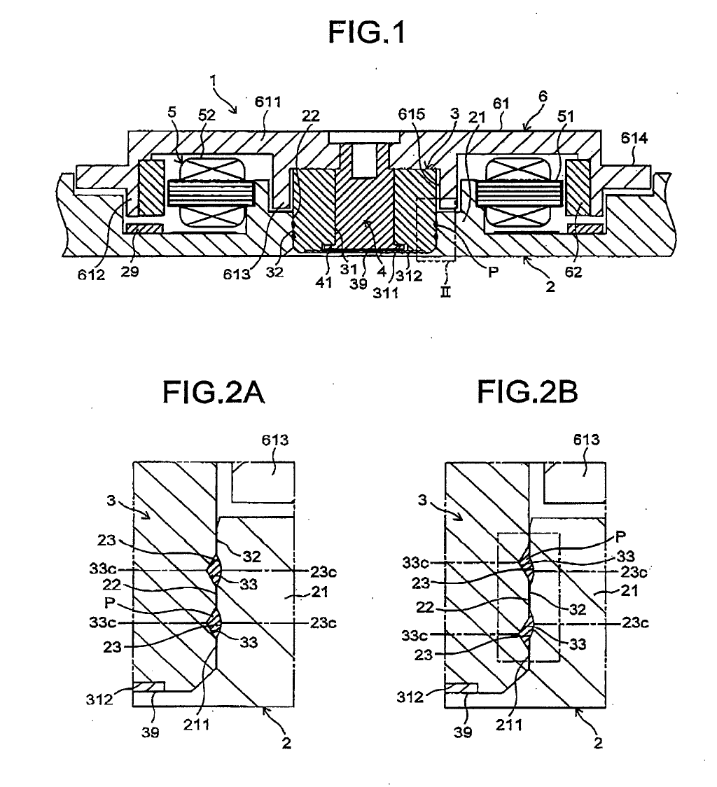

With reference to FIG. 1, a basic structure of a spindle motor 1 according to a first embodiment will be described. This spindle motor 1 is used as a driving source of a data storage device for computers including a recording disk such as a magnetic disk and an optical disc.

The spindle motor 1 includes a base 2, a shaft 4 supported by the base 2 via a sleeve (a shaft supporting member) 3, a stator assembly 5 fixed onto the base 2, and a rotor assembly 6 fixed onto the shaft 4.

In FIG. 1, the base 2 is horizontally placed, and a cylindrical holder portion 21 is provided protruding in a vertical direction. A sleeve fitting hole 211 is formed in the holder portion 21. The sleeve 3 is fitted and fixed in the sleeve fitting hole 211. A shaft insertion hole 31 is provided in the sleeve 3, and the shaft 4 having a flange portion 41 at the lower end portion thereof is inserted from the lower side and is rotatably supported. A gap between the sleeve 3 and the shaft 4 is filled with a lubricant and, on the inner circumferential surface of the shaft insertion hole 31 of the sleeve 3, a radial dynamic pressure groove (not shown) that causes the lubricant to generate a hydrodynamic pressure to support the shaft 4 is formed.

At the periphery of the opening of the shaft insertion hole 31 on the lower end surface of the sleeve 3, an annular first recess 311 is formed and, at the periphery of the opening of the first recess 311, an annular second recess 312 is formed. These recesses 311 and 312 are concentric with the shaft insertion hole 31. In the second recess 312, a disc-shaped counter plate 39 is fitted in and is hermetically fixed by such means as welding and bonding. The flange portion 41 of the shaft 4 is housed in the first recess 311 such that the flange portion 41 functions as a retainer of the shaft 4 by facing the top surface of the first recess 311 on the upper side and facing the counter plate 39 on the lower side.

In the base 2, the stator assembly 5 is fixed on an outer circumferential portion of the holder portion 21. The stator assembly 5 includes a stator core 51 composed of a laminated body of silicon steel plate fixed by being fitted onto the outer circumferential portion of the holder portion 21, and a stator coil 52 wound around the stator core 51.

The upper end portion of the shaft 4 projects from the sleeve 3 and, onto the upper end portion that projects, a central portion of a rotor hub 61 constituting the rotor assembly 6 is fixed. The rotor hub 61 is mainly constituted by a circular plate portion 611 whose upper surface is flat and, on an outer circumferential edge of the lower surface of the circular plate portion 611 and on the inner side thereof, an outer cylindrical portion 612 and an inner cylindrical portion 613, respectively, are formed protruding downward concentrically. On the inner circumferential surface of the outer cylindrical portion 612 of the rotor hub 61, a rotor magnet 62 is fixed facing the stator core 51 via a gap. The rotor magnet 62 is magnetized to a plurality of north poles and south poles. On the inner side of the inner cylindrical portion 613 of the rotor hub 61, a sleeve housing recess 615 opening downwardly is formed, and the upper end surface of the sleeve 3 faces the top surface of the sleeve housing recess 615. A thrust dynamic pressure groove (not shown) is formed on the upper end surface of the sleeve 3 that functions as a thrust bearing.

On the outer circumferential surface of the outer cylindrical portion 612 of the rotor hub 61, a flange-like disk placing portion 614 is formed. On this disk placing portion 614, the above-described disk (not shown) is mounted. Near the spindle motor 1, a recording head (not shown) that acts on the disk is disposed.

The rotor assembly 6 includes the rotor hub 61 and the rotor magnet 62, and integrally rotates with the shaft 4. On the base 2 immediately below the rotor magnet 62, disposed is an annular attraction plate 29 that stabilizes the position of the rotor assembly 6 in the axial direction during rotation.

The foregoing base 2, the sleeve 3, the shaft 4, and the rotor hub 61 are made by metal having sufficient rigidity such as stainless steel and aluminum alloy.

In the spindle motor 1 thus configured, a magnetic field is formed by the stator core 51 when the stator coil 52 is energized. The magnetic field acts on the rotor magnet 62, and thus the rotor assembly 6 rotates around the shaft 4. The foregoing disk is rotated and stopped by such operation of the spindle motor 1, and the above-described recording head writes and reads information to and from the disk.

Adhesive Structure Between Base and Sleeve

As in the foregoing, the sleeve 3 is fitted in and fixed to the sleeve fitting hole 211 of the base 2, and as the fixing means thereof, an adhesive is used.

As illustrated in FIG. 2A, on an inner circumferential surface 22 of the sleeve fitting hole 211 inside the holder portion 21 formed on the base 2, a plurality of adhesive grooves 23 (in this case, two) along the circumferential direction are formed with a given distance in the axial direction. Meanwhile, at the places that are on an outer circumferential surface 32 of the sleeve 3 and facing the adhesive grooves 23 on the base 2 side, adhesive grooves 33 on the sleeve 3 side along the circumferential direction (adhesive grooves on a shaft supporting member side) are formed. The adhesive grooves 23 and 33 on the base 2 side and the sleeve 3 side, respectively, are of a fixed width and are formed along the whole circumference spaced apart in the axial direction. The insides of the respective adhesive grooves 23 and 33 are communicating by facing each other. Consequently, the expanded-gap portions to which an adhesive P is applied are formed.

In the first embodiment, as illustrated in FIG. 2A, the adhesive grooves 23 on the base 2 side and the adhesive grooves 33 on the sleeve 3 side that face each other are disposed in a state in which both of groove center positions 23c and 33c coincide with each other in the axial direction (vertical direction in FIG. 2). The dimensions of the respective adhesive grooves 23 and 33 are formed in a range of approximately 0.5 mm or less in width and 0.15 mm or less in depth, and the number of grooves is about one to three, for example. As for the groove shape, in the sectional shape, the adhesive grooves 23 on the base 2 side are formed in an arcuated shape and the adhesive grooves 33 on the sleeve 3 side are formed in a V shape.

When assembling and fixing the sleeve 3 to the base 2, the sleeve 3 is fitted (loose fit or light press fit) into the sleeve fitting hole 211 of the base 2. The adhesive F of an anaerobic thermosetting type and the like is applied to the adhesive grooves 23 on the base 2 side and the adhesive grooves 33 on the sleeve 3 side communicating with each other. The adhesive P penetrates a gap between the base 2 and the sleeve 3 by the capillary phenomenon, and the base 2 and the sleeve 3 are fixed as the adhesive P is cured. The adhesive P is cured in a state in which the respective adhesive grooves 23 and 33 are filled with.

According to the first embodiment, the adhesive P that has cured in the adhesive grooves 23 and 33 which face each other in a manner that the groove center positions 23c and 33c coincide with each other in the axial direction, exercises the anchor effect on the inner circumferential surface 22 of the base 2 and the outer circumferential surface 32 of the sleeve 3. In the first embodiment, because the adhesive grooves 23 and 33 are formed on both the base 2 side and the sleeve 3 side, the anchor effect by the adhesive P is exercised on both the base 2 and the sleeve 3, thereby achieving the improvement in adhesive strength between the base 2 and the sleeve 3 as compared with a conventional case.

Adhesive Structure in Second Embodiment

In the above-described first embodiment, the adhesive grooves 23 on the base 2 side and the adhesive grooves 33 on the sleeve 3 side are made to face each other in a state in which the groove center positions 23c and 33c coincide with each other in the axial direction. However, it is sufficient to the adhesive grooves 23 and 33 face each other at least in part.

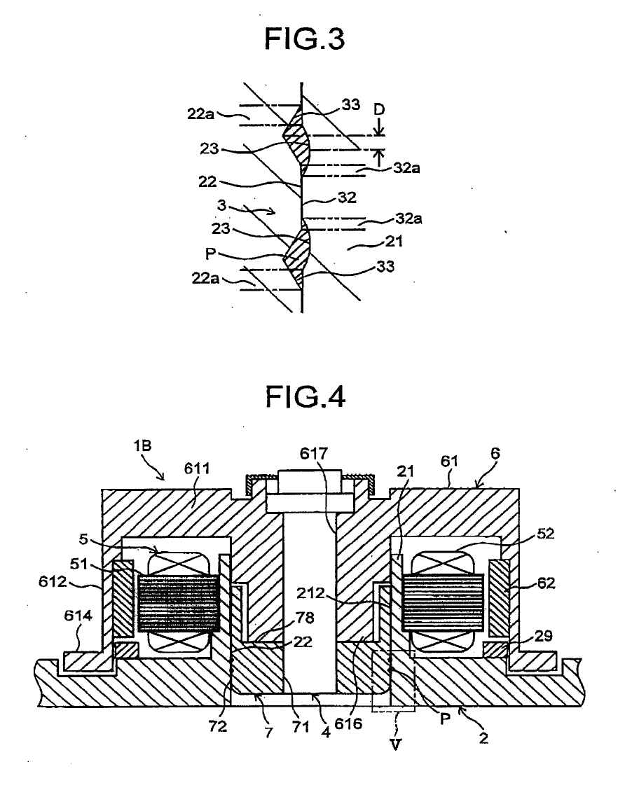

FIG. 2B illustrates one example of such embodiment. In this case, the adhesive grooves 23 on the base 2 side and the adhesive grooves 33 on the sleeve 3 side are communicating, while parts thereof face each other and the groove center positions 23c and 33c are displaced with respect to each other in the axial direction. In a second embodiment, the groove center positions 23c and 33c are displaced from each other in the axial direction such that the adhesive grooves 23 and 33 face each other by at least 50% of the respective groove widths. This is because, when the adhesive grooves 23 and 33 face each other by less than 50% of the respective groove widths, the minimum thickness of the expanded gap portions formed by the adhesive grooves 23 and 33 on the base 2 side and the sleeve 3 side becomes small and sufficient adhesive strength is not obtained. The width and depth of the respective adhesive grooves 23 and 33 are identical to those in the first embodiment. The adhesive grooves 23 on the base 2 side are positioned in the same position as illustrated in FIG. 2A and, out of the two adhesive grooves 33 on the sleeve 3 side, the adhesive groove 33 on the upper side is displaced upward in relation to the upper adhesive groove 23 on the base 2 side, and the adhesive groove 33 on the lower side is displaced downward in relation to the lower adhesive groove 23 on the base 2 side. The displaced amount (indicated by D in FIG. 3) between the groove center positions 23c and 33c of the adhesive grooves 23 and 33 on the base 2 side and the sleeve 3 side, which face, is defined in a range of 0.20 nm or less.

In the second embodiment, because the adhesive grooves 23 and 33 on the base 2 side and the sleeve 3 side face each other displaced in the axial direction, when the widths of the respective adhesive grooves 23 and 33 are equal, as illustrated in FIG. 3, the adhesive inside the respective adhesive grooves 23 and 33 adheres also onto the surfaces at which the adhesive groove 23 or 33 is not formed (in FIG. 3, an area 22 a of the inner circumferential surface 22 on the base side or an area 32 a of the outer circumferential surface 32 on the sleeve 3 side). Consequently, as compared with the first embodiment, an increase in the overall width of the adhesive grooves 23 and 33 facing each other increases the bonding area of the adhesive and, as a result, further improves the adhesive strength.

The embodiment in which the adhesive grooves 23 on the base 2 side and the adhesive grooves 33 on the sleeve 3 side are communicating while parts thereof face each other and the groove center positions 23c and 33c are displaced from each other in the axial direction may be, contrary to the embodiment illustrated in FIG. 2B, an embodiment in which the upper adhesive groove 23 on the base 2 side is displaced upward in relation to the upper adhesive groove 33 on the sleeve 3 side, and the lower adhesive groove 23 on the base 2 side is displaced downward in relation to the lower adhesive groove 33 on the sleeve 3 side. Furthermore, the embodiment also includes an embodiment in which all of the adhesive grooves 23 on the base 2 side are displaced upward in relation to all of the adhesive grooves 33 on the sleeve 3 side, and an embodiment in which all of the adhesive grooves 23 on the base 2 side are displaced downward in relation to all of the adhesive grooves 33 on the sleeve 3 side.

Shaft Supporting Member in Third Embodiment

In the spindle motor 1 in the foregoing embodiments, the shaft 4 is rotatably supported inside the sleeve 3 corresponding to a shaft supporting member. However, a structure in which a shaft is fixed to a shaft supporting member is also possible. FIG. 4 illustrates such type of spindle motor. In a spindle motor 18 illustrated in FIG. 4, the constituent elements which correspond to those illustrated in FIG. 1 are indicated by the same reference numerals, and the following describes portions of different configurations.

The inside of the cylindrical holder portion 21 formed at the center of the base 2 is defined as a bush fitting hole 212. In the bush fitting hole 212, a cup-shaped bush (shaft supporting member) 7 on which a recess 78 is formed at the upper surface is fitted in and fixed by adhesive. At the center of the recess 78 of the bush 7, a shaft-fixing hole 71 extending in the axial direction is formed to run through and, into the shaft-fixing hole 71, the lower end portion of the shaft 4 is fixed by press fitting.

In the spindle motor 18 according to a third embodiment, a bearing 616 that projects downward and formed at the center of the lower surface of the rotor hub 61 is rotatably supported with respect to the shaft 4 that is fixed to the bush 7. The shaft 4 runs through a shaft hole 617 that is formed to run through at the center of the bearing 616. The bearing 616 is fitted in the inside of the recess 78 of the bush 7, and the lower end surface thereof faces the upper surface of the recess 78 of the bush 7. The rotor assembly 6 for which the bearing 616 is rotatably supported by the shaft 4 rotates around the shaft 4 as the center, as the inner circumferential surface of the bearing 616 slides and rotates with respect to the shaft 4 via lubricant, and as the lower end surface of the bearing 616 slides on the upper surface of the recess 78 of the bush 7 via lubricant. On the inner circumferential surface and lower end surface of the bearing 616 that are the sliding surfaces, dynamic pressure grooves (depiction omitted) that support a radial load and a thrust load, respectively, are formed.

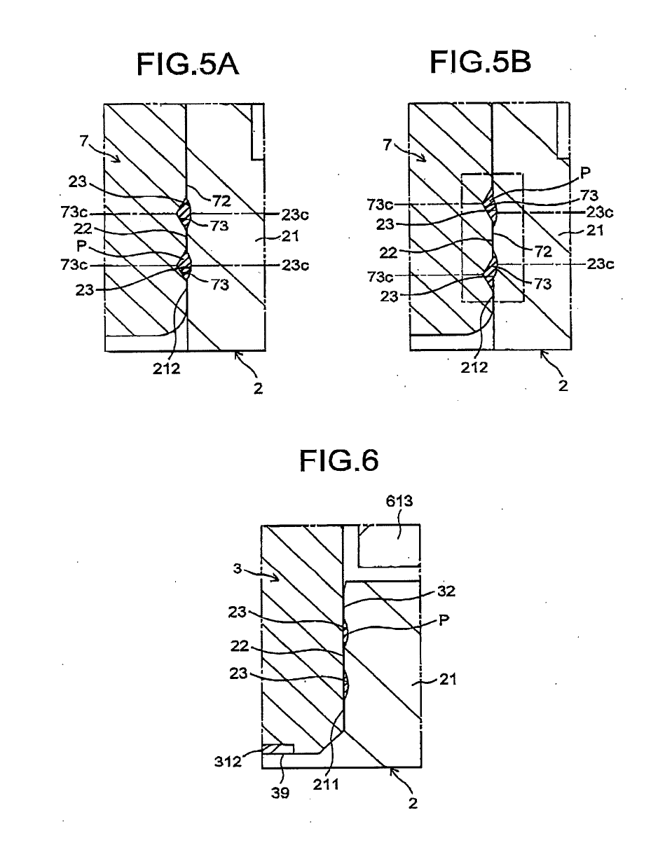

As illustrated in FIG. 5A, on the inner circumferential surface 22 of the bush fitting hole 212 inside the holder portion 21 formed on the base 2, a plurality of adhesive grooves 23 (in this case, two) along the circumferential direction are formed with a given distance in the axial direction. Meanwhile, at the places that are on an outer circumferential surface 72 of the bush 7 and facing the adhesive grooves 23 on the base 2 side, adhesive grooves 73 on the bush 7 side along the circumferential direction (adhesive grooves on a shaft supporting member side) are formed. The adhesive grooves 23 and 73 on the base 2 side and the bush 7 side, respectively, are of a fixed width and are formed along the whole circumference at given places spaced apart in the axial direction, and the insides of the respective adhesive grooves 23 and 73 are communicating by facing each other. By the adhesive P applied to these adhesive grooves 23 and 73, the bush 7 is fixed to the base 2. By the insides of the respective adhesive grooves 23 and 73 communicating with each other, the expanded-gap portions to which the adhesive P is applied are formed.

In the third embodiment, as illustrated in FIG. 5A, the adhesive grooves 23 on the base 2 side and the adhesive grooves 73 on the bush 7 side facing each other are disposed in a state in which the groove center positions 23c and 73c coincide with each other in the axial direction (vertical direction in FIG. 5). The sectional shapes of the grooves are the same as those in the foregoing first embodiment, and the adhesive grooves 23 on the base 2 side are formed in an arcuated shape and the adhesive grooves 73 on the bush 7 side are formed in a V shape.

FIG. 5B illustrates the embodiment in which, similarly to the case illustrated in FIG. 2B, the adhesive grooves 23 on the base 2 side and the adhesive grooves 73 on the bush 7 side are communicating, while parts thereof face each other and the groove center positions 23c and 73c of the adhesive grooves 23 on the base 2 side and the adhesive grooves 73 on the bush 7 side are displaced in the axial direction. In this case also, the groove center positions 23c and 73c are displaced from each other in the axial direction such that the adhesive grooves 23 and 73 face each other by at least 50% of the groove width thereof, and the displaced amount thereof is defined in a range of 0.20 nm or less.

Others

In the respective embodiments in the foregoing, the adhesive grooves 23 on the base 2 side are formed in an arcuated shape in section and the adhesive grooves 33 and 73 on the sleeve 3 side and the bush 7 side are formed in a V shape in section. However, the combination of groove shapes may be in reverse, that is, the adhesive grooves 23 on the base 2 side may be in a V shape while the adhesive grooves 33 and 73 on the sleeve 3 side and the bush 7 side may be in an arcuated shape. Furthermore, both may be in either of a V shape and an arcuated shape. However, the sectional shape of the respective adhesive grooves 23, 33, and 73 is arbitrary and is not limited to the foregoing embodiments.

In the respective adhesive grooves 23 and 33 (73) formed in multiple stages vertically, an embodiment in which the groove center positions 23c and 33c (73c) of the adhesive grooves 23 and 33 (73) that face each other coincides in the axial direction and an embodiment in which the groove center positions 23c and 33c (73c) are displaced from each other may be combined. While the dimensions and the number of the respective adhesive grooves 23, 33, and 73 are not limited to the above-described embodiments and are appropriately selected, one to three grooves are preferable.

### EXAMPLES

The effects of the embodiments are demonstrated with examples of the embodiments.

In the spindle motor having the structure illustrated in FIG. 1, the one as illustrated in FIG. 2A was defined as example 1, in which the adhesive grooves on the base side and the adhesive grooves on the sleeve side are provided in number of two, located on top and bottom and facing each other. The groove center positions of the respective adhesive grooves coincide with each other in the axial direction. The one as illustrated in FIG. 28 was defined as example 2, in which the adhesive grooves on the base side and the adhesive grooves on the sleeve side are provided in number of two, located on top and bottom and facing each other. The groove center positions of the respective adhesive grooves are displaced from each other in the axial direction. In contrast, as illustrated in FIG. 6, the one in which the adhesive grooves are formed only on the base side was defined as a comparative example. In the examples 1and 2 and the comparative example, the shape (sectional shape), depth, width, and displaced amount of the groove center positions of the respective adhesive grooves that face each other are as indicated in Table 1. To the adhesive grooves of the respective test bodies, an anaerobic adhesive was applied and the sleeve was bonded to the base.

TABLE 1

| | | COMPAR- | | | | | |
|---|---|---|---|---|---|---|---|
| | | ATIVE | | EXAM- | | EXAM- | |
| | | EXAMPLE | | PLE 1 | | PLE 2 | |
| BASE-SIDE | SECTIONAL | ARC | | ARC | | ARC | |
| | SHAPE | | | | | | |
| ADHESIVE | DEPTH | 0.04 | mm | 0.04 | mm | 0.04 | mm |
| GROOVE | WIDTH | 0.30 | mm | 0.30 | mm | 0.30 | mm |

| SLEEVE- | SECTIONAL | — | V SHAPE | | V SHAPE | |
|---|---|---|---|---|---|---|
| SIDE | SHAPE | | | | | |
| ADHESIVE | DEPTH | — | 0.05 | mm | 0.05 | mm |
| GROOVE | WIDTH | — | 0.35 | mm | 0.35 | mm |

| | | | | | |
|---|---|---|---|---|---|
| BASE-SLEEVE | — | 0 | mm | 0.1 | mm |
| ADHESIVE GROOVE | | | | | |
| DISPLACED AMOUNT | | | | | |

The test bodies of the foregoing examples 1 and 2 and the comparative example in which the sleeve had been bonded to the base were subjected to the following adhesive strength test, and the adhesive strength between the base and sleeve was evaluated.

Adhesive Strength Test

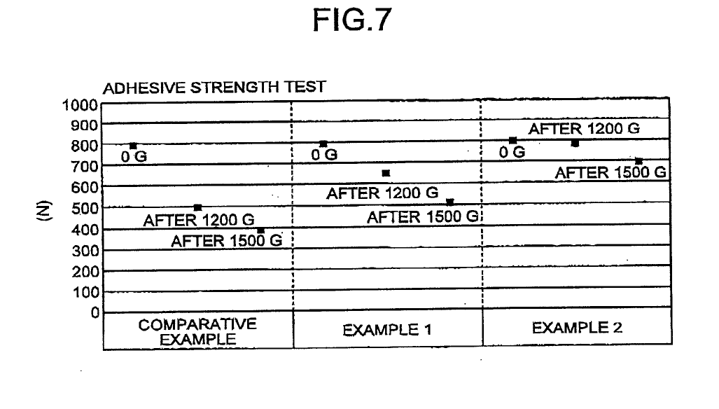

The spindle motor of the test body is dropped in the axial direction first to apply an impact thereto. The degree of impact is represented by a G value corresponding to the acceleration, and the cases of 1200 G and 1500 G are considered. Furthermore, the one that is not subjected to an impact, that is, the test body of 0 G is also prepared. Five pieces each of the test bodies (test bodies 1 to 5) subjected to 0 G, 1200 G, and 1500 G are obtained for each of the examples 1 and 2 and the comparative example. After that, the test body is held by the base in an upside-down state from the state illustrated in FIG. 1, and then a load pressing the sleeve downward is applied, and a maximum value of the load that has been pressed up to the time when the sleeve together with the rotor assembly comes off from the base is defined as the adhesive strength (N). The test result is represented in Table 2 and the average values were graphed in FIG. 7.

TABLE 2
ADHESIVE STRENGTH TEST

UNIT (N)

| | COMPARATIVE EXAMPLE | | | EXAMPLE 1 | | | EXAMPLE 2 | | |
|---|---|---|---|---|---|---|---|---|---|
| | | AFTER | AFTER | | AFTER | AFTER | | AFTER | AFTER |
| | NO | 1200 G | 1500 G | NO | 1200 G | 1500 G | NO | 1200 G | 1500 G |
| | IMPACT | IMPACT | IMPACT | IMPACT | IMPACT | IMPACT | IMPACT | IMPACT | IMPACT |
| TEST BODY | TEST | TEST | TEST | TEST | TEST | TEST | TEST | TEST | TEST |
| 1 | 764 | 590 | 332 | 880 | 600 | 576 | 793 | 833 | 646 |
| 2 | 710 | 402 | 452 | 715 | 714 | 576 | 803 | 784 | 676 |
| 3 | 872 | 619 | 338 | 813 | 549 | 443 | 842 | 754 | 774 |
| 4 | 823 | 406 | 418 | 735 | 725 | 472 | 784 | 774 | 656 |
| 5 | 788 | 448 | 384 | 813 | 657 | 470 | 764 | 754 | 715 |
| AVERAGE | 792 | 493 | 385 | 791 | 649 | 508 | 798 | 780 | 694 |

According to the foregoing result, when the impact is not applied (0 G), there is no large difference in adhesive strength among the example 1, example 2 and the comparative example. However, when the impact of 1200 G or 1500 G was applied, the examples 1 and 2 indicate a higher value of adhesive strength than that of the comparative example. Furthermore, when the examples 1 and 2 are compared, the example 2 has higher adhesive strength after receiving the impact than that of the example 1. That is, it has been revealed that, in the case that the adhesive grooves facing each other are formed on both the base side and the sleeve side, the adhesive strength after an impact is higher for the configuration where the groove center positions are displaced than the adhesive strength after an impact for the configuration where the groove center positions are not displaced.

According to the embodiments, a motor is provided for which the adhesive strength after having received an impact between a base and a shaft supporting member such as a sleeve is improved in comparison with a conventional one.

According to the embodiments, the base and the shaft supporting member are bonded by the adhesive applied to the adhesive groove on the base side and the adhesive groove on the shaft supporting member side for which at least parts thereof face each other. The adhesive applied to the respective adhesive grooves penetrates into a gap between the base and the shaft supporting member by capillary phenomenon, and the base and the shaft supporting member are fixed as the adhesive cures. The adhesive that has been applied and has cured exercises an anchor effect and contributes to the improvement of adhesive strength. In the invention, because the adhesive grooves are formed on both the base and the shaft supporting member, the anchor effect arises on both the base and the shaft supporting member, and thus the improvement in adhesive strength is achieved as compared with a conventional one in which the adhesive groove is formed only on the shaft supporting member side such as a sleeve.

A groove center position of the adhesive groove on the base side and a groove center position of the adhesive groove on the shaft supporting member side may coincide with each other in an axial direction. The groove center position here means a middle position in the width of the adhesive groove.

Moreover, a groove center position of the adhesive groove on the base side and a groove center position of the adhesive groove on the shaft supporting member side may be displaced from each other in an axial direction. In this case, an increase in the overall width of the adhesive grooves facing each other increases the adhesion area of the adhesive, and further improves the adhesive strength, which is more preferable. In this configuration, it is preferable that both of the adhesive grooves facing each other be formed so as to face each other by at least 50% of the groove width.

Although the invention has been described with respect to specific embodiments for a complete and clear disclosure, the appended claims are not to be thus limited but axe to be construed as embodying all modifications and alternative constructions that may occur to one skilled in the art that fairly fall within the basic teaching herein set forth.

What is claimed is:

1. A motor comprising:
a base including a holder portion;
a shaft supporting member fitted inside the holder portion and fixed onto an inner circumferential surface of the holder portion;
a shaft supported by the shaft supporting member;
a rotor assembly rotatably supported with respect to the shaft supporting member via the shaft; and
a stator assembly arranged on an outer circumferential portion of the holder portion,
wherein an adhesive groove on the base side and an adhesive groove on the shaft supporting member side, to which an adhesive is applied, are formed respectively on the inner circumferential surface of the holder portion and on an outer circumferential surface of the shaft supporting member facing the inner circumferential surface of the holder portion, and the adhesive groove on the base side and the adhesive groove on the shaft supporting member side are disposed to face each other at least in part.

2. The motor according to claim 1, wherein the shaft is rotatably supported by the shaft supporting member.

3. The motor according to claim 1, wherein the shaft is fixed to the shaft supporting member.

4. The motor according to claim 1, wherein a groove center position of the adhesive groove on the base side and a groove center position of the adhesive groove on the shaft supporting member side coincide with each other in an axial direction.

5. The motor according to claim 1, wherein a groove center position of the adhesive groove on the base side and a groove center position of the adhesive groove on the shaft supporting member side are displaced from each other in an axial direction.

6. The motor according to claim 1, wherein a sectional shape of the adhesive groove on the base side and a sectional shape of the adhesive groove on the shaft supporting member side are V-shaped or arcuated.

7. The motor according to claim 6, wherein the sectional shape of the adhesive groove on one of the base side and the shaft supporting member side is V-shaped while the sectional shape of the adhesive groove on the other side is arcuated.

8. The motor according to claim 1, wherein adhesive grooves are formed at a plurality of positions spaced apart in an axial direction on both the base side and the shaft supporting member side.
